(19) United States
(12) Patent Application Publication
(10) Pub. No.: US 2022/0020257 A1
(43) Pub. Date: Jan. 20, 2022

(54) METHOD AND SYSTEM FOR MONITORING A USER

(71) Applicant: KONINKLIJKE PHILIPS N.V., EINDHOVEN (NL)

(72) Inventor: Patrick KECHICHIAN, Eindhoven (NL)

(21) Appl. No.: 17/296,885

(22) PCT Filed: Nov. 19, 2019
(86) PCT No.: PCT/EP2019/081699

§ 371 Date: May 25, 2021

(30) Foreign Application Priority Data
Nov. 26, 2018 (EP) 18208313.9

(51) Int. Cl. G08B 21/04; G08B 25/01; G08B 29/04

(52) U.S. Cl. CPC G08B 21/043; G08B 21/0446; G08B 29/04; G08B 25/016; G08B 21/0492

(57) ABSTRACT

A system for monitoring a user comprising one or more movement sensors configured to be worn by the user, the one or more sensors being included in a wearable device; one or more contextual sensors configured for providing contextual information of the user; a compliance unit configured for determining a wearing compliance status of the user; the wearing compliance status being associated with the wearable device of the user; and a controller configured for monitoring the user based on the determined wearing compliance status, wherein based on the determined wearing compliance status, the controller is configured to operate the system either in a compliance mode or in a non-compliance mode, wherein in the compliance mode, the controller is configured to monitor the user based on one or more signals received from the one or more movement sensors; and wherein in the non-compliance mode, the controller is configured to monitor the user based on one or more signals received either from the combination of the one or more movement sensors and the one or more contextual sensors or from only the one or more contextual sensors.

### FIELD OF THE INVENTION

The present invention relates to the field of monitoring a user, in particular, in the field of detecting a fall of the user.

### BACKGROUND OF THE INVENTION

Personal emergency response systems (PERS) can improve the quality of life for elderly living on their own while providing ease of mind to their loved ones. These systems typically make use of a body worn device such as wristband or neck-worn pendant. During an emergency, the subscriber presses an emergency push button on the device, which establishes a two-way call with the service provider's call center.

The body-worn fall detection system such as a wrist-based device or pendant worn around a user's neck usually employs inertial sensors such as accelerometers and gyroscopes to track the device user's movements, and additionally incorporates a pressure sensor to detect height changes. Given these signals, and a subsequent extraction of features from these signals, the event as a fall or not is further classified/determined. While fall detection systems can be designed to be robust to certain degrees of wearer variability, there are situations where such systems are likely to fail, e.g. when the user removes the device from his/her body.

Other classes of fall detection systems incorporate ambient sensors such as passive infrared (PIR), camera and microphones distributed around the living space of the subscriber. Ambient sensors can also be combined with wearable fall detection systems for increased robustness. This is also described in a paper titled, “A review of wearable sensors and systems with application in rehabilitation” from Shyamal Patel et. al.

### SUMMARY OF THE INVENTION

It is an object of the present invention to provide an improved system for monitoring a user.

In a first aspect of the present invention a system for monitoring a user is provided. The system includes one or more movement sensors configured to be worn by the user, the one or more sensors being included in a wearable device; one or more contextual sensors configured for providing contextual information of the user; a compliance unit configured for determining a wearing compliance status of the user; the wearing compliance status being associated with the wearable device of the user; and a controller configured for monitoring the user based on the determined wearing compliance status, wherein based on the determined wearing compliance status, the controller is configured to operate the system either in a compliance mode or in a non-compliance mode, wherein in the compliance mode, the controller is configured to monitor the user based on one or more signals received from the one or more movement sensors; and wherein in the non-compliance mode, the controller is configured to monitor the user based on one or more signals received either from the combination of the one or more movement sensors and the one or more contextual sensors or from only the one or more contextual sensors.

The invention as claimed provides advantages that the system is overall power efficient, i.e. switching on particular sensors only when desired. Simultaneously, it avoids collection of data unnecessarily. In other words, it also optimizes storage of data and reduces any redundancy in collected data. Furthermore, the system is intelligent in the sense that it smartly switches between the modes based on wearing compliance status.

Various examples of movement sensors include but are not limited to inertial sensors, such as accelerometer, gyroscope, etc. and pressure sensors.

Various examples of contextual sensors, may also be referred to as ambient sensors, include but are not limited to Infrared (IR) sensors, including passive IR, camera, microphone(s), accelerometers and surface force/strain sensors attached or integrated in floors, etc.

In an embodiment, the wearing compliance status comprises one of wearing the wearable device in a pre-determined fashion, wearing the wearable device not in the pre-determined fashion and not wearing the wearable device.

The pre-determined fashion may be defined as a prerequisite that is prescribed by the manufacturer/service provider for a particular wearable device that enables it to monitor, in particular to detect fall, reliably. For instance, a particular fashion in which the wrist worn device has to be worn.

Furthermore, when the determined wearing compliance status is wearing the wearable device in the pre-determined fashion, the controller is configured to monitor the user in the compliance mode, and when the determined wearing compliance status is either wearing the wearable device not in the pre-determined fashion or not wearing the wearable device, the controller is configured to monitor the user in the non-compliance mode.

Advantageously, this makes the system smart and power efficient by using the resources, such as battery, other sensors, in the most optimal fashion.

In a further embodiment, the compliance unit is configured to receive information related to wearing compliance status from the user. For instance, a User Interface can be provided by means of which a user can manually provide the information related to user compliance. To further elaborate, a drop-down menu can be provided with prelisted wearing compliance status.

In a further embodiment, the compliance unit is configured to receive a signal from a sensor of the wearable device, wherein the compliance unit is configured to determine the wearing compliance status based on the received signal. Advantageously, no manual intervention is required and the compliance unit automatically determines wearing compliance status based on the sensor signals.

In a further embodiment, the system is a wearable device itself. This provides a single device to monitor the user efficiently, thus avoiding the installation of other sensors, such as contextual sensors, in the room of the user. This provides a very compact and user friendly device. An example of a wearable device is a wrist worn device. Another example of a wearable device is a neck-worn device. Other examples of wearable device may include but are not limited to a chest worn device, an ankle worn device, a head worn device, etc.

In a further embodiment, the sensor comprises a contact sensor and the signal comprises a contact signal indicative of contact of the contact sensor with the user. Various examples of a contact sensor may include but are not limited to at least one of a photoplethysmography (PPG) sensor, capacitance sensor, and skin conductance sensor, also referred to as a Galvanic Skin Response (GSR) sensor.

In a further embodiment, the neck worn device includes a flexible neck cord, a pendant, at least one strain sensor configured for sensing strain in the flexible neck cord, and an orientation sensor configured for detecting the orientation of the pendant.

In a further embodiment, the sensor comprises the at least one strain sensor and/or orientation sensor and the signal comprises a signal indicative of sensed strain/or orientation.

In a further embodiment, the system/wearable device further includes a position detection unit configured to detect position of the wearable device with respect to the user, wherein the compliance unit is further configured to determine the wearing compliance status based on the detected positon.

Advantageously, this further improves the monitoring (or detecting) fall of the user. For instance, it may be appreciated that when worn on the wrist the movement sensor may provide different motion signature then when worn on a neck. Hence, automatic detection of where the wearable device is actually worn further improves the accuracy of the detection.

In a further embodiment, a controller is configured to monitor the user based on the detected position of the wearable, wherein the controller is further configured to process the signals from the one or more movement sensors based on the detected position. To further elaborate, the controller may process the signals based on different algorithms based on the detected position. As explained earlier, the motion signatures will differ when worn at different body part and hence the processing algorithm to further monitor the user from these motion signatures will differ.

In a further embodiment, monitoring the user includes detecting if the user has fallen. In other words, detecting a fall of the user.

In a further embodiment, the system or the wearable device includes a timing unit configured sending an emergency alarm to a remote unit when the time of non-compliance exceeds a pre-determined time threshold, wherein the non-compliance is not wearing the wearable device.

In a further embodiment, the system or the wearable device includes an emergency unit, wherein the emergency unit is configured to receive input from the user for sending an emergency signal to a remote unit, wherein in the compliance mode, the emergency unit is configured in a first pre-determined configuration, and wherein in the non-compliance mode, the emergency unit is configured in a second pre-determined fashion.

In a second aspect of the present invention, a computer implemented method for monitoring a user is provided. The method includes determining a wearing compliance status of the user; the wearing compliance status being associated with a wearable device of the user; and wherein based on the determined wearing compliance status, monitoring the user based on either receiving one or more signals from one or more movement sensors of the wearable device; or receiving one or more signals from either the combination of the one or more movement sensors and one or more contextual sensors or receiving one or more signals only from the one or more contextual sensors, wherein the one or more contextual sensors are configured providing contextual information of the user.

In yet further aspects of the present invention, there is provided a corresponding computer program which comprises program code means for causing a computer to perform the steps of the methods disclosed herein when said computer program is carried out on a computer as well as a non-transitory computer-readable recording medium that stores therein a computer program product, which, when executed by a processor, causes the method disclosed herein to be performed.

It shall be understood that the computer implemented method and computer program product claims will have similar advantages as the system claims.

Preferred embodiments of the invention are defined in the dependent claims. It shall be understood that the claimed computer implemented method, computer program and medium can have similar and/or identical preferred embodiments/advantage(s) as the claimed system, in particular as defined in the dependent claims and as disclosed herein.

### BRIEF DESCRIPTION OF THE DRAWINGS

These and other aspects of the invention will be apparent from and elucidated with reference to the embodiment(s) described hereinafter. In the following drawings

FIG. 1 shows an overview a system for monitoring a user according to an exemplary embodiment;

FIG. 2 shows a flowchart depicting the method of monitoring the user according to the embodiment of the invention;

FIG. 3 shows a wrist worn device for monitoring a user according to an embodiment;

FIG. 4 shows a neck worn device for monitoring a user according to another embodiment;

FIG. 5 shows a user interface for triggering an alarm according to an embodiment;

FIG. 6 shows a user interface for triggering an alarm according to another embodiment; and

FIG. 7 shows a method of detecting wearing compliance based on a proximity sensor according to an embodiment.

### DETAILED DESCRIPTION OF THE DRAWINGS

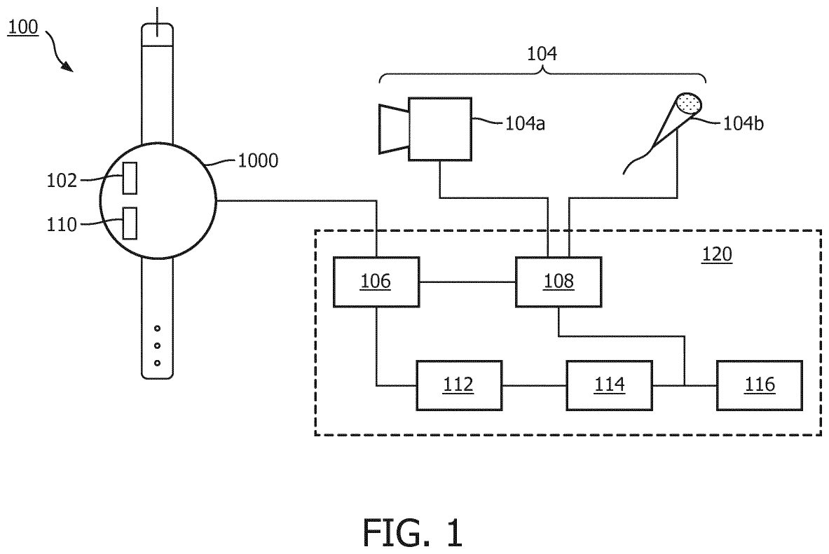

FIG. 1 shows an overview a system 100 for monitoring a user according to an exemplary embodiment. The system 100 includes one or more movement sensors 102 included in a wearable device 1000, one or more contextual sensors 104, such as at least one camera 104a, and at least one microphone 104b, a compliance unit 106, a controller 108. Optionally, the system 100 further includes a position detection unit 112, a timing unit 114 and an emergency unit 116. Further, the wearable device 1000 further includes a contact sensor 110.

Various examples of the movement sensors 102 include but are not limited to inertial sensors such as accelerometers, gyroscope, etc. and pressure sensors.

Various examples of contextual sensors 104 include but are not limited to camera 104a, microphone 104b, etc. The contextual sensors 104 provide information about the context, in particular ambient information, of the user. For instance, a GPS sensor might provide information about his location. The camera 104a gives his information of presence in a particular location.

Prior to explaining the embodiment, certain terminologies used throughout the draft are explained below for the sake of clarity.

Wearing compliance can be defined as whether the person is wearing the wearable device in the fashion that is prescribed by the manufacturer/service provider. For instance, the wrist worn device has to snugly wrap around the wrist in order to get good quality signals, for instance of movement of the user or of heart rate of the user. Further, if the wearable device is a neck worn device, then the cord of the neck worn device has to be in a particular tension around the neck in order to sense if the device is rightly worn. If the tension is not sensed right, then it might be that the neck worn device is either not worn or that it is not worn properly. Thus, if the wearing compliance is not as per the prerequisite defined by the manufacturer/service provider, then the system/device is in a non-compliance status/mode.

Compliance Mode: Mode of operation of the system/device when the device is worn properly, i.e. compliant as per the requirements of the manufacturer/service provider. In this mode, the wearing compliance status of the device is compliant with the requirement of the manufacturer/service provider.

Non-Compliance Mode: Mode of operation of the system/device when the device is not worn at all or when not worn properly.

The compliance unit 106 determines if the device is worn properly, not worn or worn but not properly. These are called as wearing compliance status. If worn properly, the wearable device is compliant. If not worn properly or not worn at all, then the device is non- or not-compliant. As explained earlier, wearing properly corresponds to the requirements from manufacturer of the wearable device. In an embodiment, the compliance unit 106 determines wearing compliance status by receiving an input from the user directly. This may be in form of a User Interface (UI), such as drop down menu, presented to the user, on the wearable device 1000 or a connected device (not shown in the figures), by means of which the user can directly provide the information to the compliance unit 106.

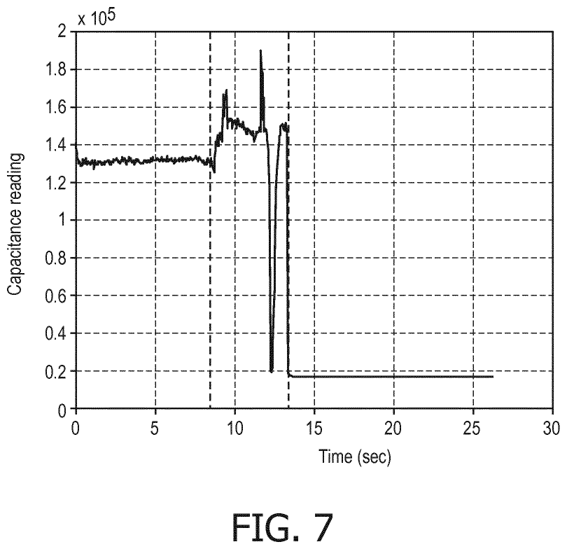

Alternatively, the compliance unit 106 determines the wearing compliance status based on a signal received from a sensor 110 of the wearable device 1000. Various examples of the sensor 110 may include but are not limited to motion sensors, such as accelerometer, or contact sensors, such as PPG sensor, GSR sensor, or proximity sensor, such as a capacitive sensor, etc. These sensors can be used alone or in combination to detect if the device is worn/not worn. Few known methodologies to detect if the wearable device is worn/not worn are disclosed in US20160022175A1, WO2017182456A1, etc. Furthermore, determination of wearing compliance based on a proximity sensor is further explained in FIG. 7. Other methodologies may also be used to determine worn/not worn status. The compliance unit 106 may be implemented as hardware and/or software.

It may be appreciated, the compliance unit 106 will further detect if the wearable device 1000 is worn but not properly by means of a signal quality threshold. This threshold can be preset/predetermined or can be adaptive. In practice, the compliance unit 106 will receive the signal from the sensor 110 but below a quality threshold, which is indicative of the wearing compliance status that the user is wearing the wearable device 1000 but not properly. Hence, it may be further appreciated if the compliance unit 106 detects a signal quality from the signal received from the sensor 110 is either equal to or greater than the signal quality threshold, then the device 1000 is worn properly.

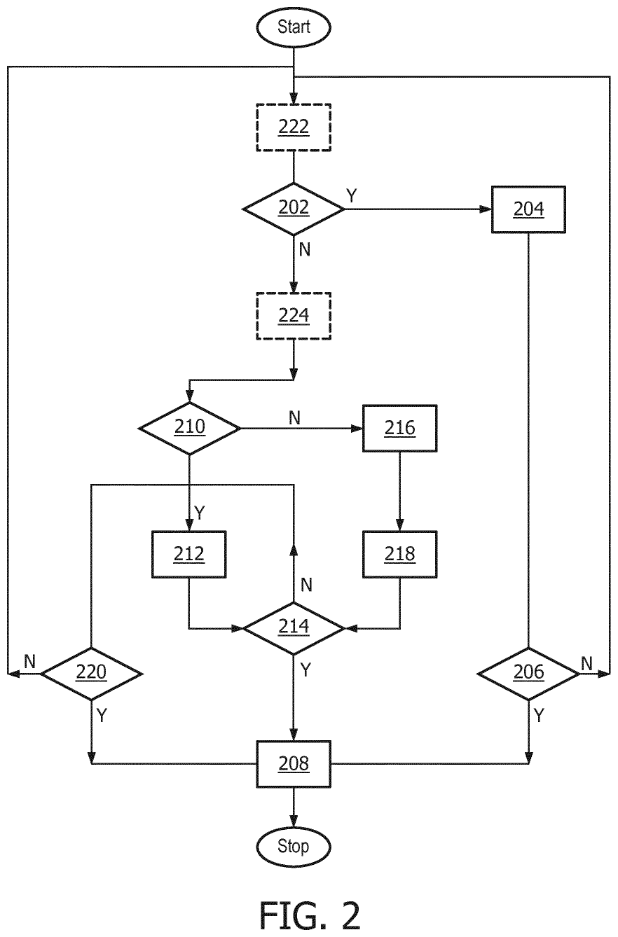

Working of the system 100 will now be explained in conjunction with a method 200 (FIG. 2) executed by the compliance unit 106 and the controller 108.

The compliance unit 106, at step 202, during the operation of the system 100, checks if the wearable device 1000 is worn properly, i.e. is the wearable device compliant.

If at step 202, it is determined that the user has worn the wearable device 1000 properly, then at step 204, the controller 108 operates the system 100 in a compliance mode and accordingly monitors the user based on movement sensors, such as accelerometer(s) and/or pressure sensor(s). In an embodiment, the controller 108 may monitor the user, in particularly fall detection, using any of fall detection algorithms, either alone or in combination, described in the patents, such as EP2147421B1, EP2274734B1, EP2329470B1, EP2369993B1, and EP2445406B1. It may be appreciated that these patents are only provided for exemplary purposes. The controller 108 may monitor the user based on any other available algorithm(s) as well.

At step 206, it is determined if the user has suffered a fall. If, at step 206, it is determined that user has suffered a fall, then at step 208, a call initiated by the controller 108. The call (audio or video) may be made to a caregiver, a service provider, a remote monitoring unit, a call center.

However, at step 202, if it is determined, by the compliance unit 106, that the wearable device 1000 is not compliant, then optionally at 224, the user may be notified by means of a message, a tactile feedback, audio feedback, etc. to adjust the wearable device 1000 such that it is worn properly.

Further, at step 202, if it is determined that the wearable device 1000 is not worn in the pre-defined fashion, i.e. worn properly, then at step 210, the compliance unit 106 checks if the device is worn but not in pre-determined fashion, i.e. not properly.

If it at step 210, it is ascertained by the compliance unit 106 that the wearable device 1000 is not worn properly (i.e. “YES”), then the controller 108, at step 212, monitors the user based on the combination of at least one movement sensor 102 and at least one contextual sensor 104a, 104b. To further elaborate, in an exemplary embodiment, the controller 108 will detect a fall of the user based on the accelerometer data and microphone data from microphone 104b. Since, the wearable device 1000 is not worn properly, the accelerometer data alone cannot be relied upon and hence the detection of fall is further augmented with microphone data, such as sound of the impact with the ground. This improves the fall detection. Alternatively, the accelerometer data can be augmented with data from the camera 104a. The controller 108, in yet another exemplary embodiment, uses data from the accelerometer, camera 104a and microphone 104b. For instance, monitoring based on multiple sensors is also explained in Castillo, J. C., Carneiro, D., Serrano-Cuerda, J., Novais, P., Fernández-Caballero, A. and Neves, J., 2014. A multi-modal approach for activity classification and fall detection. International Journal of Systems Science, 45(4), pp. 810-824.

In certain embodiments, the microphone 104b may also be connected to a voice trigger or speech recognition system (not shown in the figures) that detects/classifies certain phrases or sounds from the user as indicative of a fall and the need for help.

Thereafter at step 214, if a fall is detected by the controller 108, then a call is initiated by the controller 108 at step 208. The call may be made to a caregiver, a service provider, a remote monitoring unit, a call center. It may be apparent, if the user has not suffered the fall, the monitoring of the user continues.

Returning to step 210, if the outcome of the check of the compliance unit 106 of whether the wearable device 1000 is worn but not in pre-determined fashion is “NO”, then at step 216, the compliance unit 106 then confirms that the wearable device 1000 is not worn by the user. Thereafter, at step 218, the controller 108 monitors the user based on the contextual sensor(s) 104 only. For instance, the user may be monitored by a camera 104a. Alternatively, the user may be monitored only based on the accelerometers and/or microphone integrated in the floor to detect impact. For instance, “Fall detection of elderly through floor vibrations and sound,” Dima Litvak; Yaniv Zigel; Israel Gannot. 2008 30th Annual International Conference of the IEEE Engineering in Medicine and Biology Society. Alternatively, the user may be monitored by microphone 104b alone. It may be appreciated by the skilled person that any combination of the contextual sensors 104 is also possible.

Thereafter, if controller 108 at step 214 detects a fall by means of any of the sensors, described in step 218, either alone or in combination, then a call is initiated by the controller 108 at step 208. The call may be made to a caregiver, a service provider, a remote monitoring unit, a call center.

Though described above that a call (audio or video) is initiated by the controller 108 in case of a fall, it may be evident that other means of communication can also be envisaged, such as text message, etc.

Optionally, at step 220, when the fall is not detected at step 214, then the timing unit 114 further checks the time for which the wearable device 1000 is non-compliant, i.e. not worn/or not worn in the pre-determined fashion. The timing unit 114 compares the time of non-compliance with a pre-determined time threshold, such as 10 minutes. In the case, where the time of non-compliance exceeds the pre-determined threshold, then a call is initiated by the controller 108 at step 208. The call may be made to a caregiver, a service provider, a remote monitoring unit, a call center.

In an alternative embodiment, the method 200 further includes a step 222, in which the position detection unit 112 detects the position of the wearable device 1000 with respect to the user before the compliance unit 106 check the wearing compliance. Position detection unit 112, for instance, detects if the wearable device 1000 is worn on wrist, ankle, torso, neck, etc. and accordingly controller 108 employs corresponding algorithms to detect a fall. For instance, detection of fall based on accelerometer data from wrist will be different than the algorithm of the fall based on accelerometer data from neck. In an embodiment, the controller 108 may monitor the user, in particularly fall detection, using the algorithm disclosed in EP2926327A1.

In an embodiment, the position detection unit 112 uses the methodology disclosed in EP2432392B1. In another embodiment, the positon detection unit 112 can detect the wearing position based on the kind of accessory used by the user. In the cases, wherein the same wearable device 1000 can be worn at different positions depending upon the accessory, such as wrist band, neck cord, etc., the position detection unit 112 will detect the position based on the detected accessory. In an exemplary embodiment, each accessory may have a special electrical contact to contact corresponding contact(s) on the wearable device 1000, and these electrical contacts can be pre-defined for each type of accessory, such as a wrist band, neck cord, etc. Thus, based on the electrical contact in function, the corresponding accessory can be detected and thereby the detection of the position of the wearable device 1000.

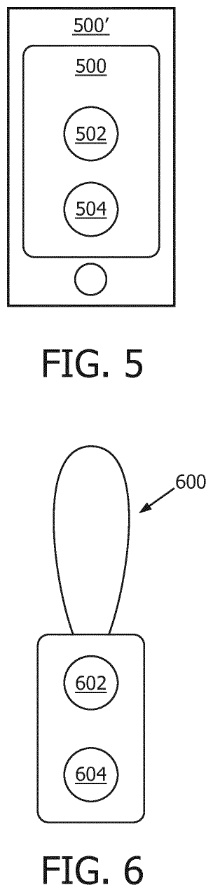

The system 100 further includes the emergency unit 116 for letting the user trigger an alarm for the remote call center or caregiver. The functionality of the emergency unit is further explained in detail in conjunction with FIG. 5.

Various units, such as the compliance unit 106, the controller 108, the position detection unit 112, the timing unit 114 and the emergency unit 116 can be further optionally located in a single apparatus, such as the apparatus 120.

The method as described above is embodied as a computer implemented method in which a computer or programmable processor is used which executes a computer readable program. Further the computer readable program is embodied in a computer program product, such as random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), and an electrically erasable programmable read-only memory (EEPROM), another like memory device. The computer program product can also be an application (app) that can be installed on a computer/a wireless communication device/a portable electronic device/wearable device.

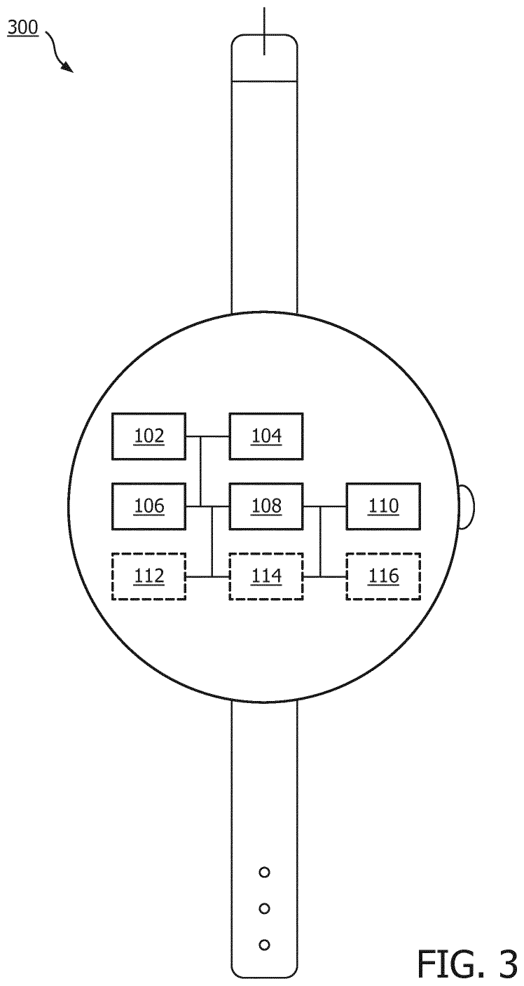

FIG. 3 shows a wrist worn device 300 for monitoring a user according to an embodiment. The wrist worn device 300 includes at least one movement sensor 102, at least one contextual sensor 104, such as the camera 104a, the microphone, 104b. In this embodiment, other units explained above in FIG. 1 are also included in the wrist worn device 300. Thus, the wrist worn device 300 further includes the compliance unit 106, the controller 108, the sensor 110, in particular a contact sensor 110. Various examples of contact sensor may include but are not limited to at least one of a photoplethysmography (PPG) sensor, capacitance sensor, and skin conductance sensor, also referred to as a Galvanic Skin Response (GSR) sensor.

The wrist worn device 300 further optionally include the position determination unit 112 and the timing unit 114.

In operation, the wrist worn device 300 will execute/employ the steps of method 200 as explained in detail conjunction with FIG. 2. Further, the methodologies disclosed above with respect to the compliance unit 106 can also be used with respect to the wrist worn device 300. Similarly, the controller 108, in conjunction with other units of the wrist worn device 300, will implement the methodologies as described above with respect to FIG. 2.

In practice, the user may wear the wrist worn device 300 and it will monitor based on either based on the movement sensors only (in the compliance mode) or based on the movement sensor(s) 102 and the contextual sensor(s) 104 (in the non-compliance mode, when not worn in the pre-determined fashion). However, if the user goes to the shower or wants to give his wrist break from the wearing the wrist worn device 300, then the contextual sensor(s) 104 only can monitor the user. For instance, the microphone 104b can remain switched ON to detect any sound associated with an impact with floor. Also, the camera 104a can remain ON to detect visuals of the user and can detect if the user has fallen out the viewing range/viewing scene. Thus, such an embodiment provides a comprehensive user monitoring.

Additionally, or alternatively, the wrist worn device 300 further includes the emergency unit 116. The operation of the emergency unit 116 will be explained in conjunction with FIG. 5 and FIG. 6.

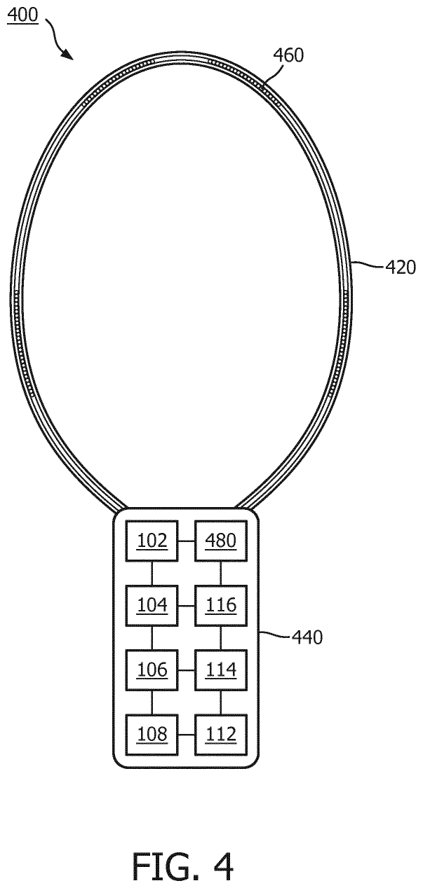

FIG. 4 shows a neck worn device 400 for monitoring a user according to another embodiment.

The neck worn device 400 includes a flexible cord 420, a pendant 440, at least one strain sensor 460 and an orientation sensor 480.

The strain sensor 460 is arranged for sensing strain in the flexible cord 420. The strain sensor 460, i.e. a strain-gage, may be located in the flexible cord in the portion of the neck worn device 400 connecting the flexible cord 420 to the pendant 440. If the neck worn device 400 is worn properly (i.e. in the pre-determined fashion), then the weight of the pendant 440 will exhibit a force on the flexible cord 420, which can be read from the strain sensor 460. Additionally, the direction of gravity as measured by the orientation sensor 480, such as an accelerometer, can further indicate the orientation of the neck worn device 400 with respect to the earth's coordinate system. The strain sensor 460 and/or orientation sensor 480 form the sensor 110 in the current the embodiment.

The neck worn device 400 also includes the compliance unit 106, the controller 108. Additionally, or optionally, the neck worn device 400 also includes the position detection unit 112, and the timing unit 114. The functionality of these units have been already explained in conjunction with FIG. 1 and FIG. 2.

Thus, based on the output of the sensor 110, the compliance unit 106 determines the wearing compliance status. In the current embodiment, the compliance unit 106 checks the measured strain with a pre-determined strain. In cases, where the measured strain matches the pre-determined strain, then it is ascertained that the neck worn device 400 is worn in the pre-determined fashion. In cases, where the measured strain is less/more than the pre-determined strain, then it is ascertained that the neck worn device 400 is worn but not in the pre-determined fashion. Furthermore, if there is no measured strain, then the compliance unit 106 ascertains that the neck worn device 400 is not worn. Further, measuring of the strain to determine wearing compliance is also explained in WO2017140537A1.

Subsequently, once the wearing compliance status is determined, in operation, the neck worn device 400 will execute/employ the steps of method 200 as explained in detail conjunction with FIG. 2. Similarly, the controller 108, in conjunction with other units of the neck worn device 400, will implement the methodologies as described above with respect to FIG. 2.

Additionally, or alternatively, the neck worn device 400 further includes the emergency unit 116. The operation of the emergency unit 116 will be explained in conjunction with FIG. 5 and FIG. 6.

FIG. 5 shows emergency unit 116 for triggering an alarm according to an embodiment. The emergency unit 116 in this embodiment is implemented as a user interface 500. The user interface 500 is implemented as a Graphical User Interface (GUI) 500. GUI 500 can be implemented on a standalone device, such as a mobile phone 500′, in particular a touch sensitive mobile phone (not shown in the figures) or a GUI 500 on the wrist worn device 300. In these implementations, the GUI 500, there is provided a first icon 502 and a second icon 504. In these implementations, based on the wearing compliance status determined by the compliance unit 106, the emergency unit 116 is accordingly configured. For instance, when in compliance mode, only the first icon 502 is activated (first pre-determined configuration). In this configuration, the user may send an alarm by pressing the icon 502/touching the icon 502. In the situation, when in non-compliance mode, optionally or additionally, the icon 504 may be also activated (second pre-determined configuration). This icon 504 may be represented as microphone icon, which will activate the microphone 104b of the system 100/wrist worn device 300/neck worn device 400 and enable the user to trigger the alarm by talking. This especially helps when for instance when wearable device 1000/wrist worn device 300/neck worn device 400 is not worn and that the person is fallen. In such a scenario, the remote center/caregiver can be easily notified.

FIG. 6 shows emergency unit 116 for triggering an alarm according to another embodiment. In this embodiment, instead of being implemented in the form of a GUI as in the above embodiment, the emergency unit 116 can be configured as button 602 that can be used in a neck worn device 600. Alternatively, it can be implemented in the device 1000, the wrist worn device 300, and the neck worn device 400. Known neck worn devices for elderly care already include an emergency button 602, when pushed, for triggering an alarm in case of an emergency (first pre-determined configuration). Thus, when in the compliance mode, the same button, also may be referred to as the emergency button 602, is used to trigger the alarm.

Furthermore, the device 600, like in the embodiments explained above in FIG. 3 and FIG. 4, also includes microphone 604, such as the microphone 104b. In the situations, when the device 600 is in non-compliance mode, the microphone 604 will also be activated by the controller 108 (not shown in the FIG. 6) so that the user can also trigger an alarm just by speaking/talking (second pre-determined configuration). This especially helps when for instance when the neck worn device 600 is not worn and that the person is fallen. In such a scenario, the remote center/caregiver can be easily notified. It may be noted that for the purposes of explanation of the emergency unit 116, other modules as described in the neck worn device 400 are not shown. In an embodiment, all or some of the modules of the neck worn device 400 can be part of the neck worn device 600. In an alternate embodiment, button such as 602 and microphone such as 604 can be part of the wrist worn device 300.

FIG. 7 shows a method of detecting wearing compliance based on a proximity sensor according to an embodiment. Various proximity sensors can be used. However, in the current embodiment, wearing compliance is explained with capacitive proximity sensors. The capacitive proximity sensors operating in shunt mode utilize at least two conductive plates, a transmitter and one or more receivers. When a current is applied to the transmitter plate, the induced electric field between transmitter and receiver is a function of the material present in this field, i.e. its dielectric. As the electric field strength changes, so does the capacitance. The latter changes are detected by measuring displacement current at the receiver plate. A properly worn device includes the capacitance and resistance of the wearer's wrist compared to a device that has been taken off or is not being worn properly. FIG. 7 shows the effect of wearing and removing a wristband device. Between 8.5 and 13 secs, the device is removed from the user's wrist.

Furthermore, and if necessary, for a given embodiment of the fall detection algorithm, the variance of the capacitance estimate can indicate a loosely worn sensor (i.e. not worn properly). In other modes, the capacitive proximity sensor may be operated in loading mode requiring a single transmit electrode. A capacitive sensor can be configured in different modes, the most well-known being shunt mode with the capacitance changing as the “dielectric” between the plates changes. In loading mode, a single plate is used and the system is driven slightly differently. For those experienced in the art, numerous other configurations exist for driving capacitive sensors are known.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. Furthermore, any patent document or a publication mentioned herein is hereby incorporated by reference.

In various embodiments, the term the controller 108, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable non-transitory medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A system for monitoring a user comprising:
a. a wearable device configured to be worn by the user, including one or more movement sensors;
b. one or more contextual sensors configured for providing contextual information of the user;
c. a compliance unit configured for determining a wearing compliance status of the user; the wearing compliance status being associated with the wearable device of the user; and
d. a controller configured for monitoring the user based on the determined wearing compliance status,
wherein based on the determined wearing compliance status, the controller is configured to operate the system either in a compliance mode or in a non-compliance mode,
wherein in the compliance mode, the controller is configured to monitor the user based on one or more signals received from the one or more movement sensors; and wherein in the non-compliance mode, the controller is configured to monitor the user based on one or more signals received either from the combination of the one or more movement sensors and the one or more contextual sensors or from only the one or more contextual sensors.
wherein the wearing compliance status comprises one of wearing the wearable device in a pre-determined fashion, wearing the wearable device not in the pre-determined fashion and not wearing the wearable device,
wherein when the determined wearing compliance status is wearing the wearable device in the pre-determined fashion, the controller is configured to monitor the user in the compliance mode, and
wherein when the determined wearing compliance status is either wearing the wearable device not in the pre-determined fashion or not wearing the wearable device, the controller is configured to monitor the user in the non-compliance mode.

2. The system according to claim 1, wherein the compliance unit is configured to receive information related to the wearing compliance status from the user.

3. The system according to claim 1, wherein the compliance unit is configured to receive a signal from a sensor of the wearable device, wherein the compliance unit is configured to determine the wearing compliance status based on the received signal.

4. The system according to claim 1, wherein the wearable device comprises the one or more contextual sensors, the compliance unit and the controller.

5. The system according to claim 3, wherein the sensor comprises a contact sensor and the signal comprises a contact signal indicative of contact of the contact sensor with the user.

6. The system according to claim 4, wherein the wearable device is a wrist worn device.

7. The system according to claim 4, wherein the wearable device is a neck-worn device, wherein the neck worn device comprises:
a. a flexible neck cord;
b. a pendant;
c. at least one strain sensor configured for sensing strain in the flexible neck cord; and
d. an orientation sensor configured for detecting the orientation of the pendant.

8. The system according to claim 3, wherein the sensor comprises the at least one strain sensor and/or the orientation sensor and the signal comprises a signal indicative of sensed strain and/or orientation.

9. The system according to claim 1 further comprising a position detection unit configured to detect the position of the wearable device with respect to the user, wherein the compliance unit is further configured to determine the wearing compliance status based on the detected position.

10. The system according to claim 9, wherein controller is configured to monitor the user based on the detected position of the wearable, wherein the controller is further configured to process the signals from the one or more movement sensors based on the detected position.

11. The system according to claim 1, wherein monitoring the user comprises detecting a fall of the user.

12. The system according to claim 1 further comprising a timing unit configured to send an emergency alarm to a remote unit when the time of non-compliance exceeds a pre-determined time threshold.

13. The system according to claim 1 further comprising an emergency unit, wherein the emergency unit is configured to receive input from the user for sending an emergency signal to a remote unit,
wherein in the compliance mode, the emergency unit is configured in a first pre-determined configuration, and
wherein in the non-compliance mode when the user is not wearing the device, the emergency unit is configured in a second pre-determined fashion.

14. A computer implemented method for monitoring a user comprising:
a. determining a wearing compliance status of the user; the wearing compliance status being associated with a wearable device of the user; and wherein based on the determined wearing compliance status,
b. monitoring the user based on either
i. receiving one or more signals from one or more movement sensors of the wearable device; or
ii. receiving one or more signals from either the combination of the one or more movement sensors and one or more contextual sensors or receiving one or more signals only from the one or more contextual sensors, wherein the one or more contextual sensors are configured providing contextual information of the user;
wherein the wearing compliance status comprises one of wearing the wearable device in a pre-determined fashion, wearing the wearable device not in the pre-determined fashion and not wearing the wearable device,
wherein when the determined wearing compliance status is wearing the wearable device in the pre-determined fashion, the controller is configured to monitor the user in a compliance mode, in which one or more signals are received from one or more movement sensors of the wearable device, and
wherein when the determined wearing compliance status is either wearing the wearable device not in the pre-determined fashion or not wearing the wearable device, the controller is configured to monitor the user in a non-compliance mode, in which one or more signals are received from either the combination of the one or more movement sensors and one or more contextual sensors or one or more signals are received only from the one or more contextual sensors.
